(19) United States
(12) Patent Application Publication
(10) Pub. No.: US 2006/0250975 A1
(43) Pub. Date: Nov. 9, 2006

(54) Method and apparatus for providing pint services with preferred delivery technology

(75) Inventors: Michel Grech, London (GB); Musa Unmehopa, Amersfoort (NL)

Correspondence Address: WILLIAMS, MORGAN & AMERSON, 10333 RICHMOND, SUITE 1100, HOUSTON, TX, 77042, US

(73) Assignee: Lucent Technologies, Inc.

(21) Appl. No.: 11/096,717

(22) Filed: Mar. 31, 2005

(51) Int. Cl. H04J 1/16

(52) U.S. Cl. 370/252

(57) ABSTRACT

A method is provided controlling communications between a first party in an internet domain and a second party in a telephony domain. The method comprises receiving a request from the first party to communicate with the second party. A preference for a type of communication used by the second party is determined, and a communications session is initiated based on the determined preference.

### BACKGROUND OF THE INVENTION

1. Field of the Invention

This invention relates generally to telecommunications, and, more particularly, to communications traversing the Internet and the Publicly Switched Telephone Network.

2. Description of the Related Art

Recently, considerable interest has developed for making telephone calls over an internet connection. That is, the ability to call a device, such as a telephone, connected to a Publicly Switched Telephone Network (PSTN) from a device, such as a computer, connected to the Internet has proven to be very desirable from at least a cost and convenience standpoint. This service has become popularly known as PSTN/Internet (PINT) internetworking service. PINT transmits voice signals over the Internet in Internet Protocol (IP) packets like e-mails and other data through gateways that switch calls between the local PSTN and the Internet.

Because PINT uses packet technology, conversations are compressed and divided into packets. These packets are encoded with a destination address and traverse the network individually. A destination gateway accepts the packets of a given address, regroups them into a single package, and then switches the call to the PSTN.

PINT services that are currently available include “Request to Call” (R2C), “Request to Fax Content” (R2F, R2FB), and “Request to Speak/Send/Play Content” (R2HC). These services, however, are all very specific as to the delivery technology and the end user device. Thus, where an internet user wishes to communicate with a telephonic device coupled to the PSTN, the user must know how to reach the telephonic device (i.e., fixed line PSTN voice call) to use PINT services.

The present invention is directed to overcoming, or at least reducing, the effects of one or more of the problems set forth above.

### SUMMARY OF THE INVENTION

In one aspect of the instant invention, a method is provided controlling communications between a first party in an internet domain and a second party in a telephony domain. The method comprises receiving a request from the first party to communicate with the second party. A preference for a type of communication used by the second party is determined, and a communications session is initiated based on the determined preference.

### BRIEF DESCRIPTION OF THE DRAWINGS

The invention may be understood by reference to the following description taken in conjunction with the accompanying drawings, in which like reference numerals identify like elements, and in which:

FIG. 1 is a block diagram of a communications system, in accordance with one embodiment of the present invention; and

FIG. 2 is a flow diagram illustrating the operation of at least a portion of the communications system of FIG. 1.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

Generally, in one embodiment of the instant invention, existing resources are used to determine a preferred delivery technology associated with a particular user in a telephony domain. The system maintains a list of subscriber preferences for end-users in order of priority (e.g., voice, SMS, MMS, video, etc). Once a PINT “click-to-communicate” request is invoked, the system checks the presence attributes of the destination party, as well as the terminal capabilities of the end-user device currently used, and subsequently establishes an appropriate communications means.

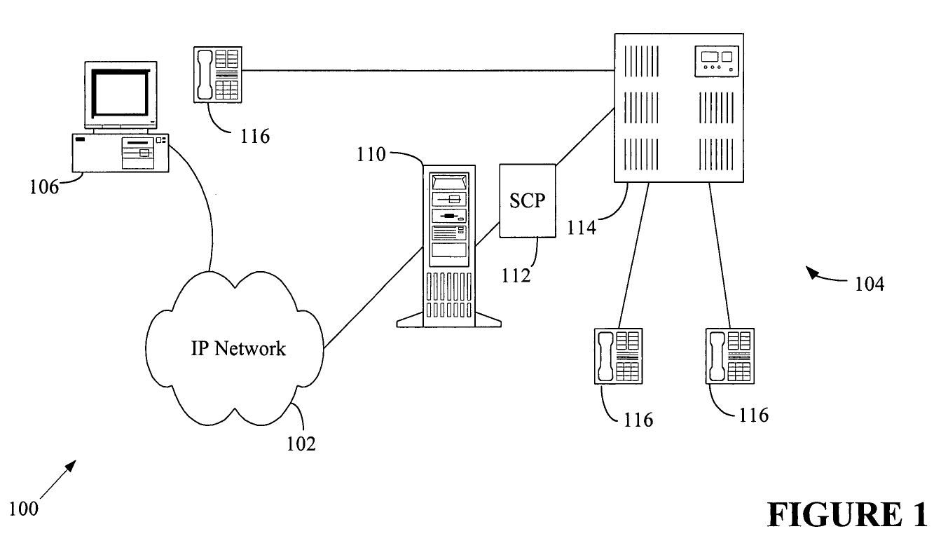

Turning now to the drawings, and specifically referring to FIG. 1, a communications system 100 is illustrated, in accordance with one embodiment of the present invention. Generally, two networks are involved in various aspects of the instant invention: an Internet Protocol (IP) Network 102, such as the Internet; and a telephony network, such as the Publicly Switched Telephone Network (PSTN) 104. Any of a variety of devices, such as a desktop computer 106, an IP enabled telephone 108, a laptop computer (not shown), a personal digital assistant (PDA) (not shown), and the like, may be coupled directly or indirectly to the IP Network 102, and each may contain software, hardware, and/or firmware designed to allow the device to initiate a call to a device in the PSTN 104.

The PSTN 104 is conventional, and thus, not discussed herein in detail so as to avoid obfuscating the instant invention. Generally, the PSTN 104 may be comprised of any of a variety of conventional equipment, including, but not limited to, switching equipment, such as might be located in a central office (CO), Private Branch Exchange (PBX) equipment, analog and digital handsets, cellular phones, and the like. The PSTN 104 is interfaced with the IP Network 102 via a gateway 110.

It is useful to describe the operation of the instant invention in the context of one party initiating a call to another party. For ease of reference, hereafter, an A party is the party in the Internet domain who invokes the “click-to-communicate” request, and a B party is the destination party in the telephony domain.

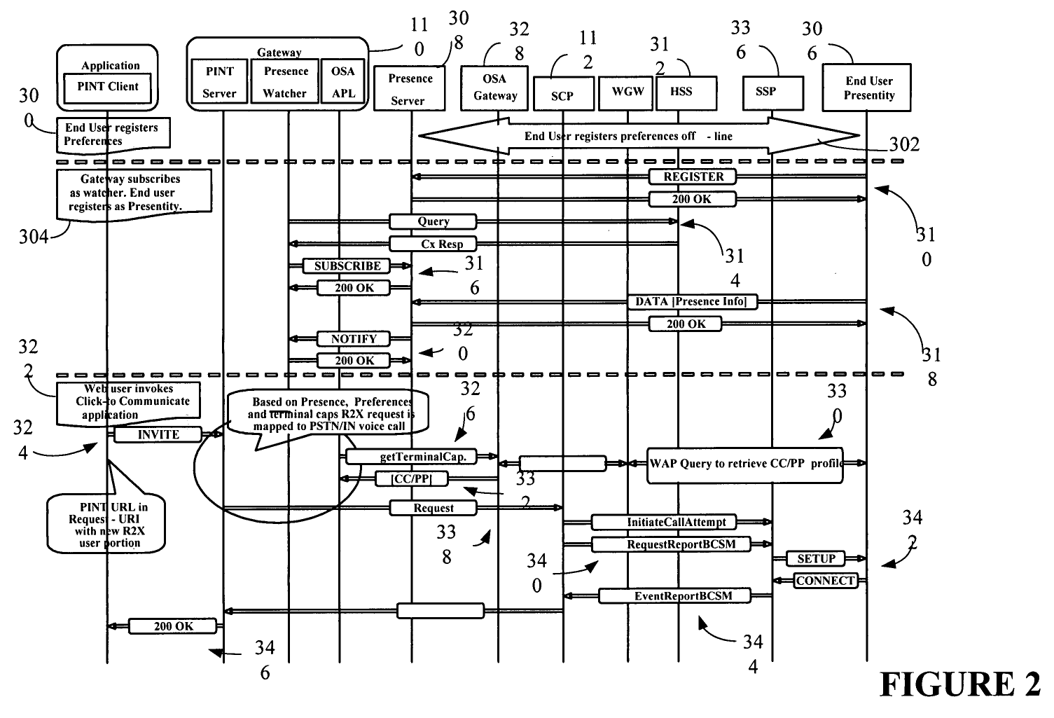

The operation of the instant invention is discussed in greater detail in the context of the flow diagram of FIG. 2. Initially, at block 300, subscriber preferences associated with the B party are registered with the gateway 110 during an off-line process, as stylistically represented at 302. These preferences may include the various communication means to be associated with the B party and the priority by which the B party wishes to be contacted. For example, the B party may indicate that he/she wishes to be contacted via a video-call application on a desktop when he/she is in his/her office, on a cell phone when connected to a wireless network, and receive a fax at a specified telephone number while not connected to any network.

At block 304, the B party registers as Presentity, so that a watcher may receive presence notifications for the B party. The registration process generally involves communications between End User Presentity 306 and a Presence Server 308, as stylistically represented by flows 310. The Gateway 110 then registers as a watcher for the B party. In order to find the appropriate Presence Server 308 associated with the B party, a H______S______S (HSS) 312 is consulted, as stylistically represented by flows 314. Once the presence Server 308 identity has been established, the Gateway registers as a watcher, as stylistically represented by flows 316.

The end-user, acting as Presentity 306, updates his/her presence information by sending a DATA message, containing the presence information, to the Presence Server 308, as indicated by flows 318. Subsequently, the watcher, i.e. the Gateway 110, is notified of a change in presence information for the B party, as indicated by the flows 320.

At block 322, the A party invokes a “click-to-communicate” request to indicate his/her wish to communicate with the B party. This is done by sending a Session Initiation Protocol (SIP) INVITE message to the Gateway 110, as indicated by flow 324. A user portion of the message is set to the new PINT service R2X (Request to Communicate), and a host portion of the message contains the domain name of the PINT service provider, i.e. pintservice.com in this case. As the A party neither has knowledge of the device currently being used by the B party, nor of the capabilities of the network at which the B party is currently registered, the A party may provide several alternative means for the connection to be established. This is achieved by listing several m-lines to indicate the alternative media types. In an Alternative embodiment of the instant invention, the presence information and subscriber preferences of the A party, which could have been previously stored, may also be used.

At this point, the Gateway 110 can compare the alternative media options provided by the A party with the subscriber preferences provided by the B party to search for a match. As the subscriber preferences provided by the B party are static, the dynamic presence information, as well as the capabilities of the terminal currently being used by the B party, is obtained. Presence information is received on a notification basis, but retrieval of the terminal capabilities is initiated by the Gateway 110. The O______S______A (OSA) Terminal Capabilities Service Capability Feature (OSA TC SCF) may be used for this. The Gateway 110 invokes a getTerminalCapabilities method, as indicated by flow 326, on the OSA Gateway 328. This method invocation is mapped by the OSA Gateway 329 onto a W______A______P (WAP) protocol operation to obtain a C______C______/P______P______ (CC/PP) profile of the subscriber's end-user device, as indicated by flow 330. The CC/PP profile is returned to the Gateway 110 as a result of this synchronous method invocation, as indicated by flow 332.

The OSA Terminal Capabilities functionality is known to those of ordinary skill in the art, and thus, is not discussed in detail herein so as to avoid unnecessarily obfuscating the instant invention.

At this point the Gateway 110 “knows” how to proceed with the R2X request from the A party. Based on the A party media alternatives, the B party subscriber preferences, the B party presence information, and the B party terminal capabilities, a specific delivery technology and communication means is established. In this example, the R2X request results in a voice call. The PINT Server functionality of the Gateway 110 contacts an S______C______P (SCP) 334 and requests it to send an INAP InitiateCallAttempt protocol operation to an S______S______P (SSP) 336, as indicated by flows 338. The SCP 334 may additionally arm a dynamic trigger so that the application may receive event reports for this particular call, as indicated by flow 340. The SSP 336 may set up the call to the B party, as indicated by flows 342. A CONNECT message will be result in an INAP EventReportBCSM protocol operation to the SCP 334, as indicated by flow 344, which in turn will result in a notification to the application, by means of a SIP 200 OK, as indicated by flow 346.

In the embodiment disclosed herein, the Gateway 110 combines the functionality of the PINT Server, the Presence Watcher, and the OSA Client Application. However, those skilled in the art will appreciate that various portions of this functionality could be distributed to other components in the system without departing from the spirit and scope of the instant invention. For example, the SIP Presence in the gateway 110 could be replaced by OSA P______A______M (PAM), which could simplify the operation of the Gateway 110.

One exemplary embodiment of the SIP INVITE for the “Click-to-Communicate” service is depicted below:
INVITE sip:R2X@pintservice.com SIP/2.0
Via: SIP/2.0/UDP 123.45.67.8
From: sip:a-party@lucent.com
To: sip:b-party@telco.com
Call-ID: 12345678@lucent.com
Cseq: 1 INVITE
Content-type:application/sdp
Content-length: . . .
v=0
s=R2X
e=a-party@lucent.com
m=video 2232 RTP/AVP 31
m=audio 1 voice
m=application 1 fax URI

The particular SIP INVITE shown here indicates that the A party wishes to communicate via video, voice, of fax. No “user” URL parameter is used to indicate e.g. “user=phone”. The “R2X” user portion of the SIP URL is new, and indicates the new PINT Request to Communicate service.

Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system's memories or registers or other such information storage, transmission or display devices.

Those skilled in the art will appreciate that the various system layers, routines, or modules illustrated in the various embodiments herein may be executable control units. The control units may include a microprocessor, a microcontroller, a digital signal processor, a processor card (including one or more microprocessors or controllers), or other control or computing devices. The storage devices referred to in this discussion may include one or more machine-readable storage media for storing data and instructions. The storage media may include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy, removable disks; other magnetic media including tape; and optical media such as compact disks (CDs) or digital video disks (DVDs). Instructions that make up the various software layers, routines, or modules in the various systems may be stored in respective storage devices. The instructions when executed by the control units cause the corresponding system to perform programmed acts.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. Consequently, the method, system and portions thereof and of the described method and system may be implemented in different locations, such as the wireless unit, the base station, a base station controller and/or mobile switching center. Moreover, processing circuitry required to implement and use the described system may be implemented in application specific integrated circuits, software-driven processing circuitry, firmware, programmable logic devices, hardware, discrete components or arrangements of the above components as would be understood by one of ordinary skill in the art with the benefit of this disclosure. It is therefore evident that the particular embodiments disclosed above may be altered or modified and all such variations are considered within the scope and spirit of the invention. Accordingly, the protection sought herein is as set forth in the claims below.

We claim:

1. A method for controlling communications between a first party in an internet domain and a second party in a telephony domain, comprising:
receiving a request from the first party to communicate with the second party;
determining a preference for a type of communication used by the second party;
initiating a communications session based on the determined preference.

2. A method, as set forth in claim 1, wherein determining a preference for a type of communication used by the second party further comprises determining a preferential order for a plurality of types of communication used by the second party.

3. A method, as set forth in claim 2, further comprising, determining the second users presence relative to the plurality of types of communications used by the second party, and wherein initiating a communications session based on the determined preference further comprises initiating a communications session based on the determined preference and presence.

4. A method, as set forth in claim 1, wherein determining a preference for a type of communication used by the second party further comprises registering information regarding a plurality of types of communication used by the second party and associating the types of communication with an order of preference, and wherein initiating a communications session based on the determined preference further comprises initiating a communications session using the type of communication having the highest preference.

5. A method, as set forth in claim 1, further comprising determining types of communication available to the first user, and wherein initiating a communications session based on the determined preference further comprises initiating a communications session based on the determined preference and the types of communication available to the first user.

6. A method, as set forth in claim 1, wherein receiving the request from the first party to communicate with the second party further comprises receiving a Session Initiation Protocol INVITE message.

7. A method, as set forth in claim 6, wherein receiving the Session Initiation Protocol INVITE message further comprises receiving a Session Initiation Protocol INVITE message in which a user portion of the message includes a Request to Communicate.

8. A method, as set forth in claim 6, wherein receiving the Session Initiation Protocol INVITE message further comprises receiving a Session Initiation Protocol INVITE message in which a host portion of the message contains a domain name of a PINT service provider.

9. A method for controlling communications between a first party in an internet domain and a second party in a telephony domain, comprising:
receiving a request from the first party to communicate with the second party;
determining a presence of the second party relative to a plurality of types of communication used by the second party;
initiating a communications session based on the determined presence.

10. A method, as set forth in claim 9, wherein determining a presence of the second party relative to a plurality of types of communication used by the second party further comprises determining a preferential order for the plurality of types of communication used by the second party.

11. A method, as set forth in claim 10, wherein initiating the communications session based on the determined preference further comprises initiating a communications session based on the determined preferential order and presence.

12. A method, as set forth in claim 10, wherein determining the preferential order for the plurality of types of communication used by the second party further comprises registering information regarding a plurality of types of communication used by the second party and associating the types of communication with an order of preference, and wherein initiating a communications session based on the determined presence further comprises initiating a communications session using the type of communication having the highest preference.

13. A method, as set forth in claim 9, further comprising determining types of communication available to the first user, and wherein initiating a communications session based on the determined presence further comprises initiating a communications session based on the determined presence and the types of communication available to the first user.

14. A method, as set forth in claim 9, wherein receiving the request from the first party to communicate with the second party further comprises receiving a Session Initiation Protocol INVITE message.

15. A method, as set forth in claim 14, wherein receiving the Session Initiation Protocol INVITE message further comprises receiving a Session Initiation Protocol INVITE message in which a user portion of the message includes a Request to Communicate.

16. A method, as set forth in claim 15, wherein receiving the Session Initiation Protocol INVITE message further comprises receiving a Session Initiation Protocol INVITE message in which a host portion of the message contains a domain name of a PINT service provider.
